(19) United States
(12) Patent Application Publication
(10) Pub. No.: US 2026/0122575 A1
(43) Pub. Date: Apr. 30, 2026

(54) SYSTEMS AND METHODS FOR ENABLING ECPRI FUNCTIONALITY IN A CPRI-BASED DISTRIBUTED ANTENNA SYSTEM (DAS) FOR IMPROVED FUNCTIONALITY FOR A WIRELESS COMMUNICATION SYSTEM (WCS)

(71) Applicant: ANI Acquisition Sub, LLC, Boca Raton, FL (US)

(72) Inventors: Raja Bachu, Kendall Park, NJ (US); Risto Karkkainen, Moraga, CA (US); Shirish Nagaraj, Pleasanton, CA (US); Deepak Pengoria, San Jose, CA (US)

(73) Assignee: ANI Acquisition Sub, LLC, Boca Raton, FL (US)

(21) Appl. No.: 19/368,428

(22) Filed: Oct. 24, 2025

Related U.S. Application Data
(60) Provisional application No. 63/711,969, filed on Oct. 25, 2024.

(51) Int. Cl. H04W 52/02; H04W 28/18; H04W 64/00

(52) U.S. Cl. CPC H04W 52/0235; H04W 28/18; H04W 64/00

(57) ABSTRACT

Systems and methods for enabling enhanced Common Public Radio Interface (eCPRI) functionality in a CPRI-based distributed antenna system (DAS) in a wireless communication system (WCS) are disclosed. In particular, energy-saving and positioning functions that are provided in eCPRI are now enabled in a CPRI-based system. In an exemplary aspect, energy-saving functions are enabled by providing a flag in a channel sent from a headend unit (HEU) to a remote unit, where the flag indicates that an antenna carrier (AxC) is on or off. The remote unit may stop processing the AxC (i.e., not sending or receiving signals) based on the flag. The remote unit may determine when all AxC are off, and, responsive to that determination, turn off power amplifiers and/or other circuits to save power. Another flag may indicate that the remote unit may enter a low-power mode, allowing the remote unit to transmit using less power.

### CROSS-REFERENCE TO RELATED APPLICATIONS

This application claims the benefit of priority under 35 U.S.C. §119(e) of U.S. Provisional Application No. 63/711,969, filed October 25, 2024, the contents of which are incorporated herein by reference in its entirety.

### BACKGROUND

The technology of the disclosure relates generally to a wireless communication system (WCS) and, more particularly, to a distributed antenna system (DAS) with a Common Public Radio Interface (CPRI) link configured to carry enhanced CPRI (eCPRI) functions.

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communication systems have been provided to transmit and/or distribute communication signals to wireless devices called “clients,” “client devices,” or “wireless client devices,” which must reside within the wireless range or “cell coverage area” to communicate with an access point device. Example applications where communication systems can be used to provide or enhance coverage for wireless services include public safety, cellular telephony, wireless local access networks (LANs), location tracking, and medical telemetry inside buildings and over campuses. One approach to deploying a communication system involves the use of a radio node/base station that transmits communication signals distributed over physical communication medium remote unit forming radio frequency (RF) antenna coverage areas, also referred to as “antenna coverage areas.” The remote units each contain or are configured to couple to one or more antennas configured to support the desired frequency(ies) of the radio node to provide the antenna coverage areas. Antenna coverage areas can have a radius in the range from a few meters up to twenty meters, as an example. Another example of a communication system includes radio nodes, such as base stations, that form cell radio access networks, wherein the radio nodes are configured to transmit communication signals wirelessly directly to client devices without being distributed through intermediate remote units.

Many communication systems rely on the CPRI protocol to handle communication. CPRI defines an interface between radio equipment control (REC) and radio equipment. More recently, the Enhanced-CPRI or eCPRI has been deployed to handle the increased functionality of 5G cellular systems. However, given the popularity of CPRI systems, there is room for innovation in allowing eCPRI functionality to be enabled on a CPRI system.

### SUMMARY

Aspects disclosed in the detailed description include systems and methods for enabling enhanced Common Public Radio Interface (eCPRI) functionality in a Common Public Radio Interface (CPRI) based distributed antenna system (DAS) in a wireless communication system (WCS). In particular, energy-saving functions and positioning functions that are provided in eCPRI are now enabled in a CPRI-based system. In an exemplary aspect, energy-saving functions are enabled by providing a flag in a channel sent from a headend unit (HEU) to a remote unit, where the flag indicates that an antenna carrier (AxC) is on or off. The remote unit may stop processing the AxC (i.e., not sending or receiving signals) based on the flag. Further, the remote unit may determine when all AxC are off and, responsive to that determination, turn off power amplifiers and/or other circuits to save power. Still another flag may indicate that the remote unit may enter a low-power mode, allowing the remote unit to transmit using less power. Still further, another flag may indicate that a given portion of a carrier (e.g., a half-slot of a frame) is muted. While muted, the remote unit does not have to send or receive signals for that carrier. These and other flags may be used in a WCS to effectuate position detection. Enabling eCPRI functions in CPRI systems allows for backward compatibility and extends the life cycle of CPRI systems, which may be advantageous for commercial reasons.

In this regard, in one aspect, a WCS is disclosed. The WCS includes a radio unit configured to send wireless signals to user equipment and a HEU communicatively coupled to the radio unit through a CPRI-compliant link. The WCS is configured to receive an enhanced CPRI (eCPRI) signal from an outside source over an eCPRI- compliant link, determine that an energy-saving command is present in the eCPRI signal, and responsive to determining the energy-saving command is present in the eCPRI signal, send a CPRI-compliant signal with an indication of an energy saving function to the radio unit.

In another aspect, a HEU is disclosed. The HEU includes an eCPRI interface configured to receive an eCPRI-compliant signal from a remote source, where the eCPRI-compliant signal contains an energy-saving command or a positioning command, a CPRI interface configured to send CPRI-compliant signals to a remote radio unit; and a control circuit coupled to the eCPRI interface and the CPRI interface. The HEU is configured to assemble a CPRI-compliant frame comprising an indication of the energy-saving command or the positioning command and send the CPRI-compliant frame.

In another aspect, a radio unit is disclosed. The radio unit includes a CPRI interface configured to couple to a CPRI-compliant link and a control circuit coupled to the CPRI interface. The radio unit is configured to receive an indication in a CPRI-compliant frame, wherein the indication relates to an eCPRI-enabled command that is not available in a CPRI native frame and responsive to receiving the indication, implement the eCPRI-enabled command.

In another aspect, a method is disclosed. The method includes receiving an eCPRI-compliant signal at a headend unit of a WCS wherein the eCPRI-compliant signal comprises a command that is not available in a native CPRI-compliant system, embedding an indication of the command in a CPRI-compliant frame and sending the CPRI-compliant frame to a remote radio unit over a CPRI-compliant link.

### BRIEF DESCRIPTION OF THE DRAWINGS

FIG. 1 is a block diagram of an exemplary wireless communication system (WCS) that may implement enhanced Common Public Radio Interface (eCPRI) functions over Common Public Radio Interface (CPRI) links;

FIG. 2 is a flowchart illustrating an exemplary process for implementing eCPRI functions over CPRI links in the WCS of FIG. 1;

FIG. 3 is a schematic diagram of a CPRI link between elements of the WCS of FIG. 1;

FIG. 4 is a diagram of a CPRI frame illustrating where indications of the eCPRI function may be embedded in a frame sent over a CPRI link;

FIG. 5 is a flowchart illustrating a process used within the radio unit to perform energy-saving operations;

FIG. 6 is a flowchart illustrating a process for muting signals in the time domain;

FIG. 7 is a flowchart illustrating the ability to mute half-slots that may be reused for positioning purposes.

FIG. 8 is a schematic diagram of another exemplary multi-radio WCS, including but not limited to the multi-radio WCS of previous Figures;

FIG. 9 is a partial schematic cut-away diagram of an exemplary building infrastructure that includes a multi-radio WCS of previous Figures;

FIG. 10 is a schematic diagram of an exemplary mobile telecommunications environment that includes a multi-radio WCS of previous Figures; and

FIG. 11 is a block diagram of an exemplary processor-based system that can be used by any of the computers or modules of the present disclosure.

### DETAILED DESCRIPTION

Aspects disclosed in the detailed description include systems and methods for enabling enhanced Common Public Radio Interface (eCPRI) functionality in a Common Public Radio Interface (CPRI) based distributed antenna system (DAS) in a wireless communication system (WCS). In particular, energy-saving functions and positioning functions that are provided in eCPRI are now enabled in a CPRI-based system. In an exemplary aspect, energy-saving functions are enabled by providing a flag in a channel sent from a headend unit (HEU) to a remote unit, where the flag indicates that an antenna carrier (AxC) is on or off. The remote unit may stop processing the AxC (i.e., not sending or receiving signals) based on the flag. Further, the remote unit may determine when all AxC are off, and responsive to that determination, turn off power amplifiers and/or other circuits to save power. Still another flag may indicate that the remote unit may enter a low-power mode, allowing the remote unit to transmit using less power. Still further, another flag may indicate that a given portion of a carrier (e.g., a half-slot of a frame) is muted. While muted, the remote unit does not have to send or receive signals for that carrier. These and other flags may be used in a WCS to effectuate position detection. Enabling eCPRI functions in CPRI systems allows for backward compatibility and extends the life cycle of CPRI systems, which may be advantageous for commercial reasons.

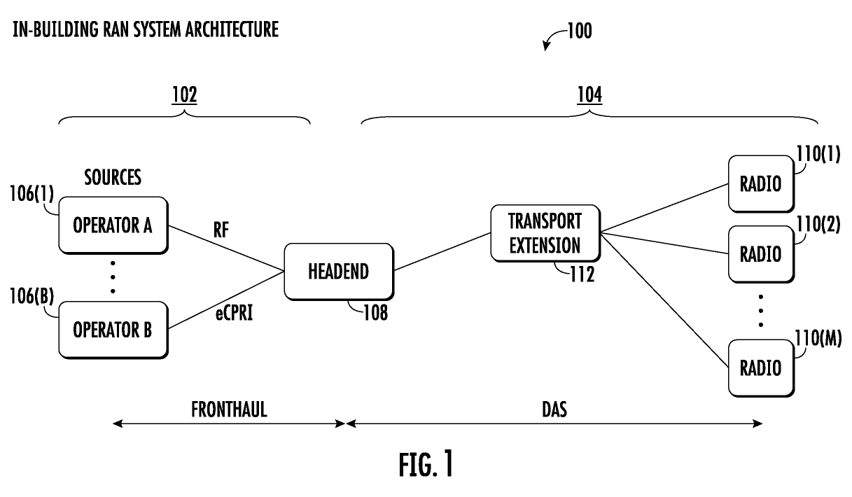

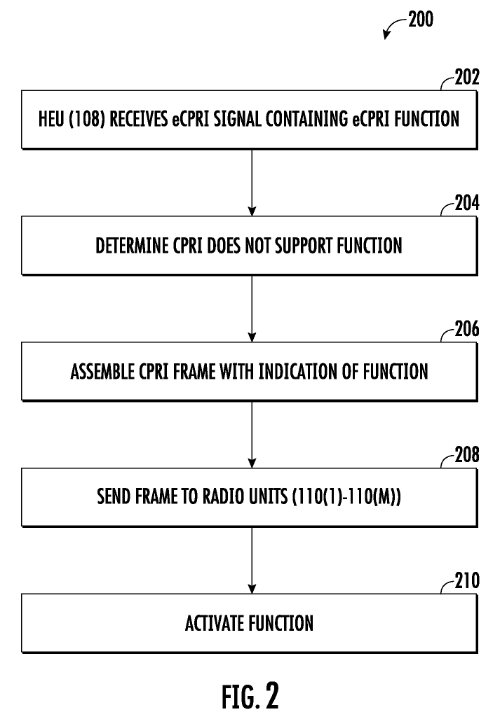

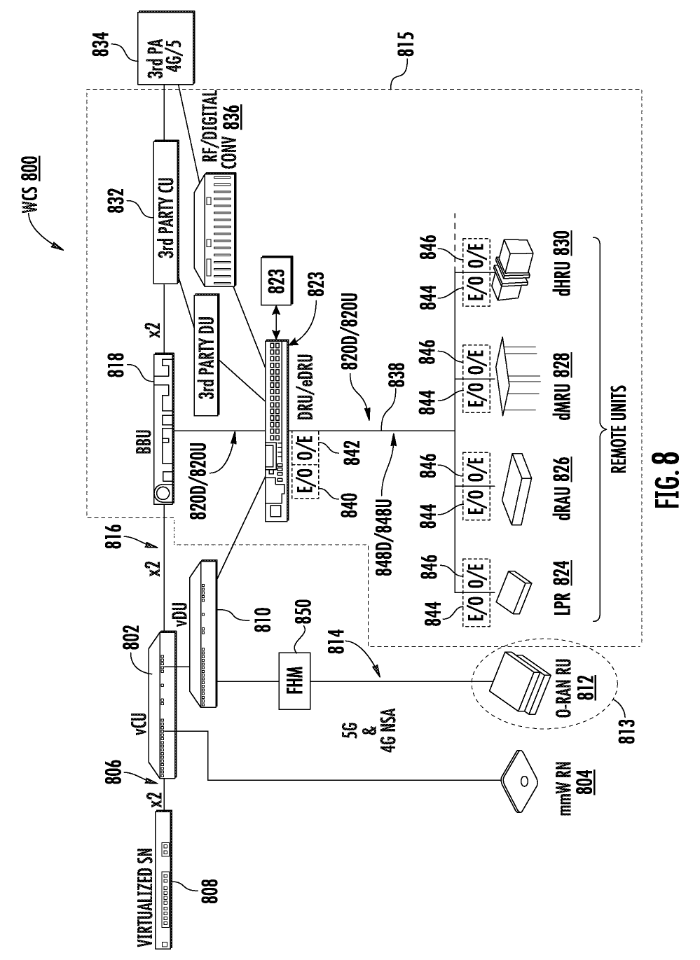

Before addressing aspects of the present disclosure, a brief overview of a WCS 100 is provided with reference to FIG. 1. A discussion of exemplary aspects of the present disclosure begins below with reference to FIG. 2. More details on a WCS are provided as additional information beginning below with reference to FIG. 8.

In this regard, FIG. 1 illustrates a WCS 100 having a fronthaul side 102 and a distributed antenna system (DAS) 104. The fronthaul side 102 includes one or more sources 106(1)-106(B), which couple to a headend unit (HEU) 108 through communication links. In exemplary aspects, the communication links may be radio frequency (RF) or eCPRI links. The HEU 108 communicates with radio units 110(1)-110(M) optionally through a transport extension unit 112. The links used to communicate from the HEU 108 to the radio units 110(1)-110(M) are CPRI links. It should be noted that the eCPRI standard has functions that are not natively supported in the older CPRI standard. As such, there may be signals from the sources 106(1)-106(B) that are not readily capable of being sent to the radio units 110(1)-110(M). Prominent among the eCPRI functions that are not supported in CPRI are energy-saving functions and position determination functions. CPRI-based DAS have widespread deployment and are still being deployed as of this writing. Accordingly, there are reasons to enable these sorts of eCPRI functions on CRPI-based DAS.

Exemplary aspects of the present disclosure contemplate using one or more bits in a CPRI frame to indicate the use of one or more eCPRI functions that are not natively supported in a CPRI message. In particular, bits in the control and management (C&M) channel may be used to provide this indication. More particularly, vendor specific bits or reserved bits may be so used. Responsive to receiving a frame with such a bit indicator from the HEU 108, the radio units 110(1)-110(M) may change behavior such that the desired function is provided. It should be appreciated that the CPRI/eCPRI border (e.g., typically the HEU 108) will provide the translation of the eCPRI function and insert the appropriate bit(s) into the CPRI frame.

FIG. 2 provides a flowchart for a process 200 corresponding to a high-level perspective of the present disclosure. In particular, the process 200 begins when the HEU 108 receives an eCPRI signal from a source 106(1)-106(B) containing an eCPRI function (block 202). The HEU 108 determines that the function is not supported by CPRI (block 204). The HEU 108 assembles a CPRI frame containing an indication for the function (block 206). As noted above, this indication may be a bit in a C&M channel and, more particularly, may be a bit in a vendor-specific area or a reserved bit. The HEU 108 then sends the frame to the radio units 110(1)-110(M) (block 208). The radio units 110(1)-110(M) evaluate an address to see if the command is for that specific radio unit and, if so, activate the function (block 210).

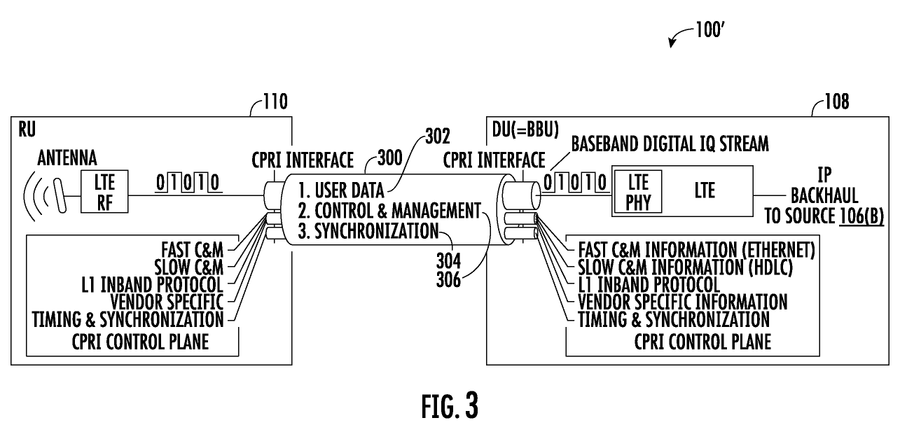

FIG. 3 is a schematic diagram of a portion 100’ of the WCS 100 of FIG. 1. In particular, the CPRI link 300 between the HEU 108 and a radio unit 110 is illustrated. The CPRI link 300 may have a user data channel 302, a synchronization channel 304, and, relevant to the present disclosure, a C&M channel 306. The user data channel 302 has a baseband digital stream. The synchronization channel 304 has timing and synchronization information. The C&M channel 306 includes fast C&M information, slow C&M information, L1 inband protocol information, vendor-specific information, and reserved bits.

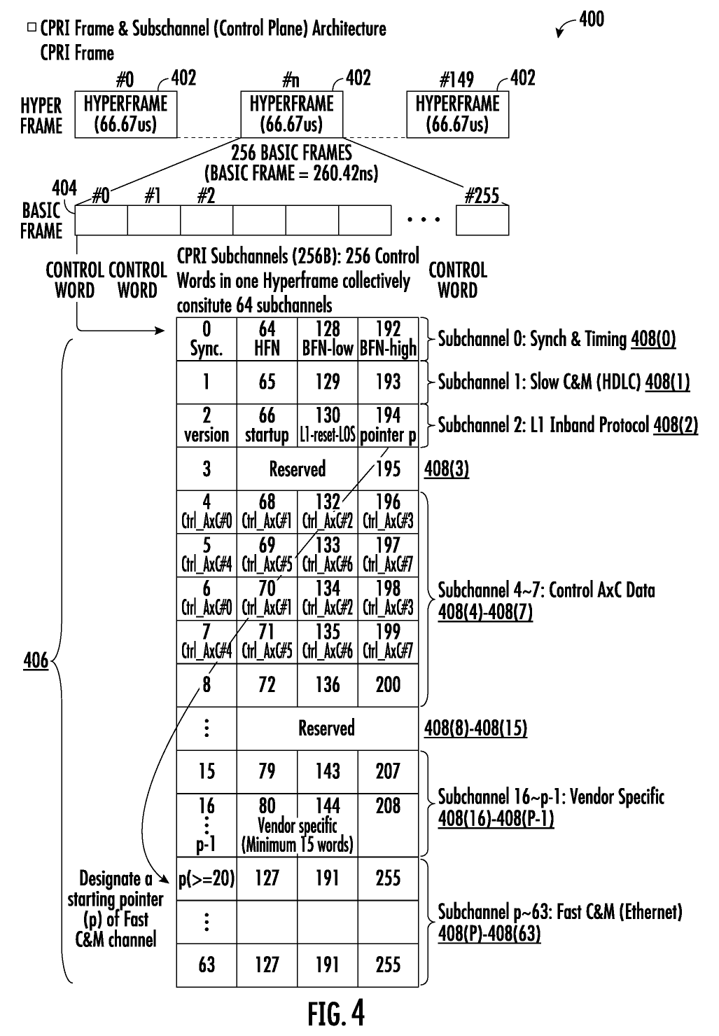

FIG. 4 provides additional information about a signal flow 400 that goes across the C&M channel 306 of FIG. 3. The signal flow 400 includes multiple hyperframes 402, each composed of multiple basic frames 404. CPRI defines each hyperframe 402 as being 66.67 microseconds long and having 256 basic frames 404, where each basic frame 404 is 260.42 nanoseconds long. The hyperframe 402 may have subchannels that are spread across the basic frames 404. Thus, block 406 illustrates 64 subchannels including a synchronization and timing subchannel 408(0), a slow C&M subchannel 408(1), an L1 inband protocol subchannel 408(2), a reserved subchannel 408(3), control AxC data subchannels 408(4)-408(7), reserved subchannels 408(8)-408(15), vendor-specific subchannels 408(16)-408(P-1), and fast C&M subchannels 408(P)-408(63). Indications of eCPRI functions may be embedded as bits in the reserved subchannel 408(3) or the vendor-specific subchannels 408(16)-408(P-1).

As noted above, energy savings and positioning functions are of particular interest. Within the energy savings function, there are four functions of interest. These functions include carrier and cell on/off (i.e., within a coverage area having multiple cells or carriers, some of them can be turned off in low load conditions), RF channel configuration (i.e., changing a number of active transmit and receive antennas), active low power mode (i.e., relaxation of RF requirements to enable higher interference in adjacent channels), and advanced sleep modes (e.g., muting parts of a signal in time domain to result in low power operation).

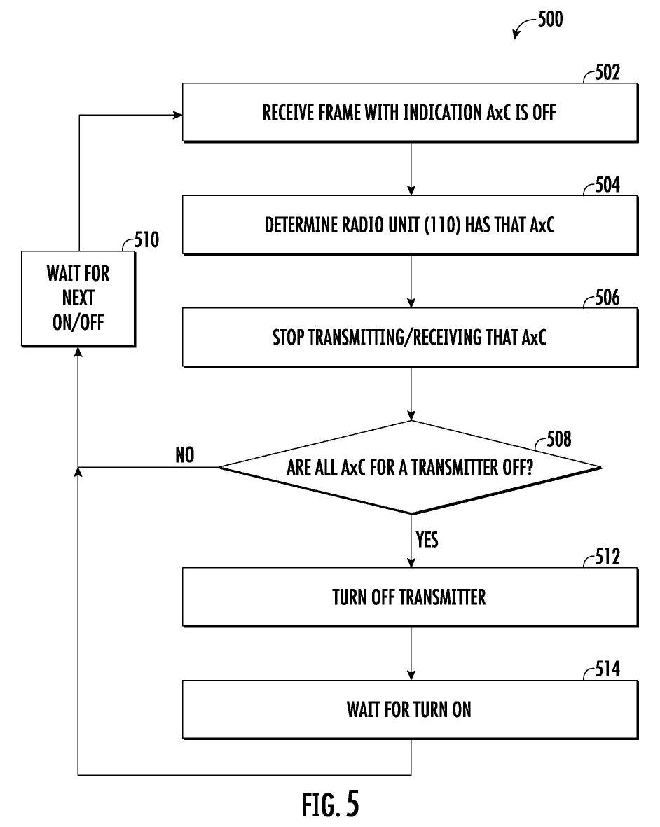

The present disclosure contemplates a bit that indicates whether an AxC is active or not. AxC is the CPRI term for an antenna container. Thus, the radio units 110(1)-110(M) will receive frames that indicate whether a given AxC is on or off for that particular radio unit 110. A second bit may indicate a low-power mode. These bits enable the first three energy-saving functions as explained in the processes of FIGS. 5 & 6. Both of these solutions are frequency domain solutions. The advanced sleep mode is a time-domain solution and requires a slightly different approach.

FIG. 5 illustrates a flowchart of a process 500 used within the radio unit 110 to perform energy-saving operations. The process 500 begins with the radio unit 110 receiving a frame with an indication that an AxC is off (block 502). The radio unit 110 determines that the radio unit 110 has that AxC (block 504). That is, a given radio unit 110 may not have all AxC managed by the HEU 108, but when the radio unit 110 has that AxC, the radio unit 110 may stop transmitting and receiving that AxC (block 506). While an AxC is turned off in this manner, the circuits are not active, and power savings are achieved.

With continued reference to FIG. 5, the radio unit 110 may determine if all AxC for a transmitter within the radio unit 110 are turned off (block 508). If the answer is no to block 508, then the radio unit 110 waits for the next on/off command from the HEU 108 (block 510). If, however, the answer to block 508 is yes, all the AxC are off, then the radio unit 110 may turn off that transmitter (block 512). Turning off the transmitter may include turning off power amplifiers and/or other radio frequency integrated circuits (RFICs) within the radio unit 110. Again, when these circuits are turned off, power savings are achieved. The radio unit 110 then waits for a turn on (block 514) (at which time, the radio unit 110 may turn on the transmitter).

Thus, the process 500 shows how a radio unit 110 may perform the first two energy-saving functions through just one bit for AxC, indicating whether the AxC is active.

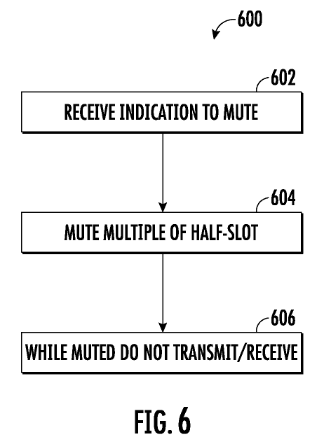

FIG. 6 illustrates a process 600 for muting signals in the time domain. The process 600 begins with the radio unit 110 receiving an indication to mute (block 602). This indication may be one bit per carrier per basic frame and can be used to mute multiples of half slots. That is, frame boundaries are already known, but subcarrier spacing and start symbols may be provided. Addressing at the symbol level may not be possible with CPRI numerology (150 hyperframes, 256 basic frames, and 16/96 words per basic frame), so the half slot may be an acceptable proxy. Responsive to receipt of the indication, the radio unit 110 may mute the half-slot (s) (block 604). While muted, there is no transmission or reception (block 606), and power is conserved.

3GPP and O-RAN both contemplate positioning for uplink and downlink. That is, both support downlink and uplink positioning measurements in a shared cell architecture. In the downlink, positioning reference signals (PRS) can be transmitted from different radios of the shared cell with different PRS configurations. Thus, for positioning, when a PRS assigned to a radio unit in a shared cell is transmitted, other radio units are muted. The PRS is assigned to different radio units in a shared cell and is time multiplexed. In the uplink, sound reference signals (SRS) can be received from different radio units of the shared cell. To give accurate measurements, the SRS from all radio units except one are muted before combining at the sector hub. Again, by time multiplexing, the SRS from each radio unit may be evaluated. Enhanced Cell Identification (E-CID) uses much of the same methodology using different signals and measurements.

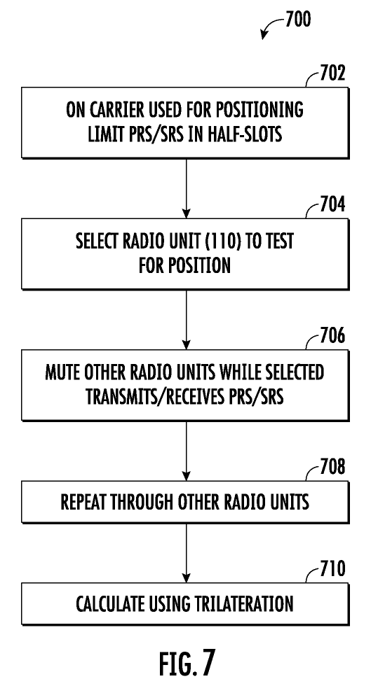

The ability to mute half-slots may be reused for positioning purposes. That is, as illustrated by process 700 of FIG. 7, the HEU 108 may limit PRS/SRS to half-slots on the carrier used for positioning (block 702). The HEU 108 may then select a radio unit 110 to test for position (block 704). The HEU 108 sends a command to mute other radio units 110(1)-110(M) while the selected radio unit 110 transmits/receives PRS/SRS (block 706). The muting may be done one radio unit at a time, or a bitmap may be used to signal which radio units 110(1)-110(M) are muted/not muted. The muting/not muting is repeated through other radio units 110(1)-110(M) (block 708). From these various measurements, the position may be calculated by the HEU 108 using trilateration (block 710).

Relevantly, the mapping of PRS configuration or SRS resources to radio unit identification may be done ahead of time. Further, the location of the radio units 110(1)-110(M) relative to the HEU 108 is known, along with appurtenant delays associated with the relative positions. These delays may be factored into the trilateration calculations as is well understood.

While a DAS is specifically contemplated, it should be appreciated that other WCS that rely on CPRI links may benefit from the present disclosure. Accordingly, in the interests of full disclosure, a discussion of a WCS is provided.

FIG. 8 is a schematic diagram of an exemplary multi-radio WCS 800 (“WCS 800”) that can include one or more RAN systems implemented according to a RAN standard (e.g., O-RAN standard), such as WCS 100 described above and configured to determine the geo-location of active user devices in the WCS based on a user device report created for each user device that indicates the uplink power in a received uplink reference signal in each of a plurality of RUs as a result of a scheduled user device transmitting an uplink reference signal and TOA information regarding the received uplink reference signal in each of the RUs, according to any of the embodiments disclosed herein. The multi-radio WCS 800 supports both legacy 4G LTE, 4G/5G non-standalone (NSA), and 5G standalone communications systems. As shown in FIG. 8, a centralized services node 802 (which can be a CU described above) is provided that is configured to interface with a core network to exchange communications data and distribute the communications data as radio signals to remote units, which can be the RUs described above. In this example, the centralized services node 802 is configured to support distributed communications services to an mmWave radio node 804. The mmWave radio node 804 is an example of a wireless device that can be configured to selectively control whether received transmit channels are transmitted through an antenna array. Despite the fact that only one mmWave radio node 804 is shown in FIG. 8, it should be appreciated that the multi-radio WCS 800 can be configured to include additional mmWave radio nodes 804, as needed. Other non-mmWave radio nodes, such as the radio units 110(1)-110(M) described above, may also be present. The functions of the centralized services node 802 can be virtualized through an x2 interface 806 to another services node 808. The centralized services node 802 can also include one or more internal radio nodes that are configured to be interfaced with a DU 810 (which can be a virtual DU and/or a HEU 108 described above) to distribute communications signals (e.g., communications channels) to a plurality of O-RAN RUs 812 (only one RU shown for convenience) that are configured to be communicatively coupled through an O-RAN interface 814. The O-RAN RUs 812 are another example of a wireless device that can be configured to selectively control whether received transmit channels are transmitted through an antenna array. The O-RAN RUs 812 are each configured to communicate downlink and uplink communications signals in the coverage cell(s) 813.

The centralized services node 802 can also be interfaced with a DCS 815 through an x2 interface 816. Specifically, the centralized services node 802 can be interfaced with a digital baseband unit (BBU) 818 in the DCS that can provide a digital signal source to the centralized services node 802. The digital BBU 818 can be configured to process user device reports based on TOA information from uplink communication signals received from the DRU 1622, as described above, to determine the geolocation of user devices in the multi-radio WCS 800. The digital BBU 818 may be configured to provide a signal source to the centralized services node 802 to provide electrical downlink communications signals 820D (electrical downlink communications signals 820D can include downlink channels) to a digital routing unit (DRU) 822 as part of a digital DAS. The DRU 822 is communicatively coupled to a processing circuit 823. The DRU 822 is configured to split and distribute the electrical downlink communications signals 820D to different types of remote wireless devices, including a low-power remote unit (LPR) 824, a radio antenna unit (dRAU) 826, a mid-power remote unit (dMRU) 828, and/or a high-power remote unit (dHRU) 830. The DRU 822 is also configured to combine electrical uplink communications signals 820U (electrical uplink communications signals 820U can include uplink channels) received from the LPR 824, the dRAU 826, the dMRU 828, and/or the dHRU 830 and provide the combined electrical uplink communications signals 820U to the digital BBU 818. The digital BBU 818 is also configured to interface with a third-party central unit 832 and/or an analog source 834 through a radio frequency (RF)/digital converter 836.

The DRU 822 may be coupled to the LPR 824, the dRAU 826, the dMRU 828, an/or the dHRU 830 via an optical fiber-based communications medium 838. In this regard, the DRU 822 can include a respective electrical-to-optical (E/O) converter 840 and a respective optical-to-electrical (O/E) converter 842. Likewise, each of the LPR 824, the dRAU 826, the dMRU 828, and the dHRU 830 can include a respective E/O converter 844 and a respective O/E converter 846.

The E/O converter 840 at the DRU 822 is configured to convert the electrical downlink communications signals 820D into optical downlink communications signals 820D for distribution to the LPR 824, the dRAU 826, the dMRU 828, and/or the dHRU 830 via the optical fiber-based communications medium 838. The O/E converter 850 at each of the LPR 824, the dRAU 826, the dMRU 828, and/or the dHRU 830 is configured to convert the optical downlink communications signals 820D back to the electrical downlink communications signals 820D. The E/O converter 844 at each of the LPR 824, the dRAU 826, the dMRU 828, and the dHRU 830 is configured to convert the electrical uplink communications signals 820U into optical uplink communications signals 820U. The O/E converter 842 at the DRU 822 is configured to convert the optical uplink communications signals 820U back to the electrical uplink communications signals 820U.

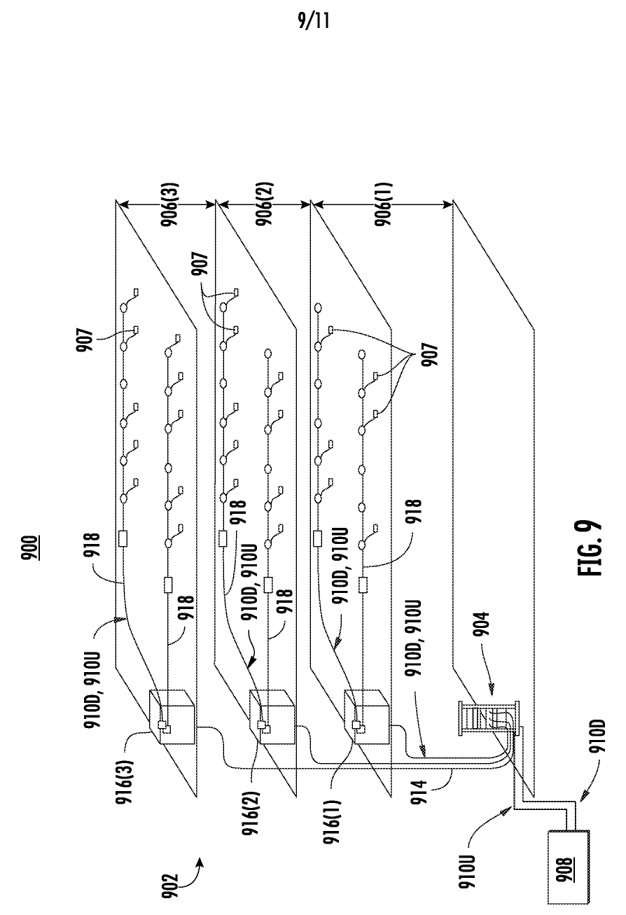

FIG. 9 is a partial schematic cut-away diagram of an exemplary building infrastructure 900 that includes an exemplary multi-radio WCS 902, wherein the multi-radio WCS 902 includes multiple RANs 904 implemented according to a RAN standard (e.g., O-RAN standard). The multi-radio WCS 802 is configured to process user device reports based on TOA information from uplink communication signals, as described above, to determine the geo-location of user devices in the multi-radio WCS 902. The building infrastructure 900 in this embodiment includes a first (ground) floor 906(1), a second floor 906(2), and a third floor 906(3). The floors 906(1)-906(3) are serviced by one or more RANs 904 to provide antenna coverage areas 907 in the building infrastructure 900. The RANs 904 are communicatively coupled to a core network 908 to receive downlink communications signals 910D (downlink communications signals 910D can include downlink channels) from the core network 908. The RANs 904 are communicatively coupled to a respective plurality of RUs 912 to distribute the downlink communications signals 910D to the RUs 912 and to receive uplink communications signals 910U (uplink communications signals 910U can include uplink channels) from the RUs 912, as previously discussed above. Any RU 912 can be shared by any of the multiple RANs 904.

The downlink communications signals 910D and the uplink communications signals 910U communicated between the RANs 904 and the RUs 912 are carried over a riser cable 914. The riser cable 914 may be routed through interconnect units (ICUs) 916(1)-916(3) dedicated to each of the floors 906(1)-906(3) that route the downlink communications signals 910D and the uplink communications signals 910U to the RUs 912 and also provide power to the RUs 912 via array cables 918.

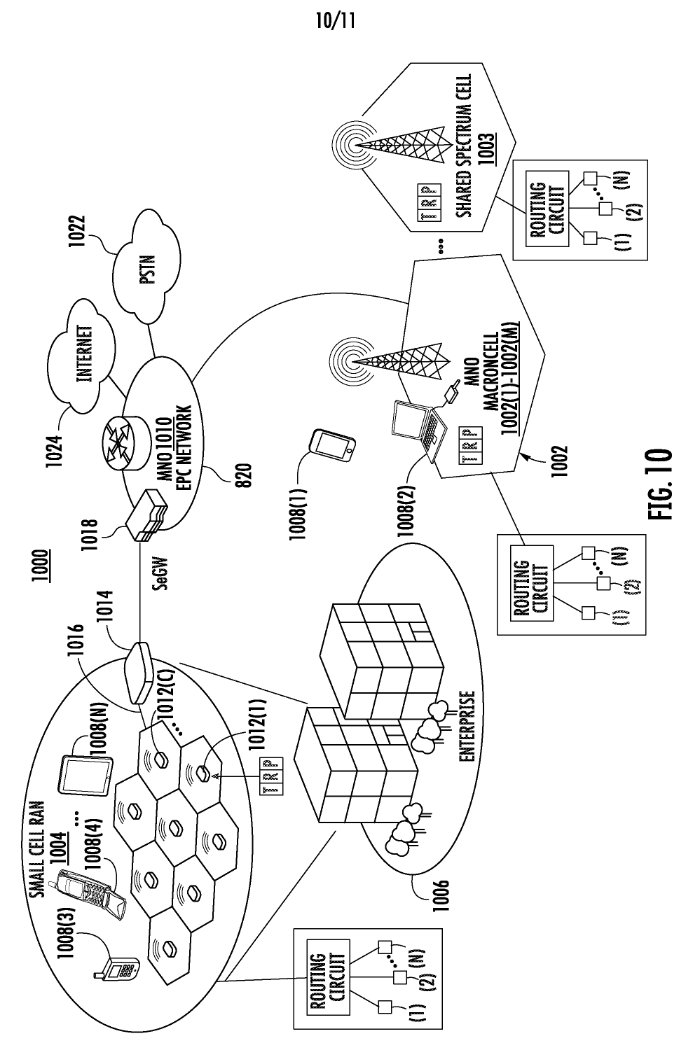

FIG. 10 is a schematic diagram of an exemplary mobile telecommunications multi-radio WCSs 1000 analogous to WCS 100. The multi-radio WCS 1000 includes multiple RANs implemented according to a RAN standard (e.g., O-RAN standard). The multi-radio WCS 1000 is configured to process user device reports based on TOA information from uplink communication signals, as described above, to determine the geolocation of user devices in the multi-radio WCS 1000.

In this regard, multi-radio WCS 1000 includes exemplary macrocell RANs 1002(1)-1002(M) (“macrocells 1002(1)-1002(M)”) and an exemplary small cell RAN 1004 located within an enterprise environment 1006 and configured to service mobile communications between a user mobile communications device 1008(1)-1008(N) to a mobile network operator (MNO) 1010. A serving RAN for the user mobile communications devices 1008(1)-1008(N) is a RAN or cell in the RAN in which the user mobile communications devices 1008(1)-1008(N) have an established communications session with the exchange of mobile communications signals for mobile communications. Thus, a serving RAN may also be referred to herein as a serving cell. For example, the user mobile communications devices 1008(3)-1008(N) in FIG. 10 are being serviced by the small cell RAN 1004, whereas the user mobile communications devices 1008(1) and 1008(2) are being serviced by the macrocell 1002. The macrocell 1002 is an MNO macrocell in this example. The macrocell 1002 can be or include a wireless device(s) that can be configured to selectively control whether received transmit channels are transmitted through an antenna array of the wireless device. However, a shared spectrum RAN 1003 (also referred to as “shared spectrum cell 1003”) includes a macrocell in this example and supports communications on frequencies that are not solely licensed to a particular MNO, such as CBRS for example, and thus may service user mobile communications devices 1008(1)-1008(N) independent of a particular MNO. The macrocell 1002 can be or include a wireless device(s) that can be configured to selectively control whether received transmit channels are transmitted through an antenna array of the wireless device. The macrocell 1002 can be a wireless device that can be configured to selectively control whether received transmit channels are transmitted through an antenna array of the wireless device. For example, the shared spectrum cell 1003 may be operated by a third party that is not an MNO and wherein the shared spectrum cell 1003 supports CBRS. The MNO macrocell 1002, the shared spectrum cell 1003, and the small cell RAN 1004 may be neighboring radio access systems to each other, meaning that some or all can be in proximity to each other such that a user mobile communications device 1008(3)-1008(N) may be able to be in communications range of two or more of the MNO microcell(s) 1002, the shared spectrum cell 1003, and the small cell RAN 1004 depending on the location of the user mobile communications devices 1008(3)-1008(N).

In FIG. 10, the multi-radio WCS 1000 in this example is arranged as an LTE system as described by the Third Generation Partnership Project (3GPP) as an evolution of the GSM/UMTS standards (Global System for Mobile Communication/Universal Mobile Telecommunications System). It is emphasized, however, that the aspects described herein may also be applicable to other network types and protocols. The multi-radio WCS 1000 includes the enterprise environment 1006 in which the small cell RAN 1004 is implemented. The small cell RAN 1004 includes a plurality of small cell radio nodes 1012(1)-1012(C), which are wireless devices that can be configured to selectively control whether received transmit channels are transmitted through an antenna array of the wireless devices. Each small cell radio node 1012(1)-1012(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 10, the small cell RAN 1004 includes one or more services nodes (represented as a single services node 1014) that manage and control the small cell radio nodes 1012(1)-1012(C). In alternative implementations, the management and control functionality may be incorporated into a radio node, distributed among nodes, or implemented remotely (i.e., using infrastructure external to the small cell RAN 1004). The small cell radio nodes 1012(1)-1012(C) are coupled to the services node 1014 over a direct or local area network (LAN) connection 1016 as an example, typically using secure IPsec tunnels. The small cell radio nodes 1012(1)-1012(C) can include multi-operator radio nodes. The services node 1014 aggregates voice and data traffic from the small cell radio nodes 1012(1)-1012(C) and provides connectivity over an IPsec tunnel to a security gateway (SeGW) 1011 in a network 1020 (e.g., evolved packet core (EPC) network in a 4G network, or 5G Core in a 5G network) of the MNO 1010. The network 1020 is typically configured to communicate with a public switched telephone network (PSTN) 1022 to carry circuit-switched traffic, as well as for communicating with an external packet-switched network such as the Internet 1024.

The multi-radio WCS 1000 also generally includes a node (e.g., eNodeB or gNodeB) base station, or “macrocell” 1002. The radio coverage area of the macrocell 1002 is typically much larger than that of a small cell where the extent of coverage often depends on the base station configuration and surrounding geography. Thus, a given user mobile communications device 1008(3)-1008(N) may achieve connectivity to the network 1020 (e.g., EPC network in a 4G network or 5G Core in a 5G network) through either a macrocell 1002 or small cell radio node 1012(1)-1012(C) in the small cell RAN 1004 in the multi-radio WCS 1000.

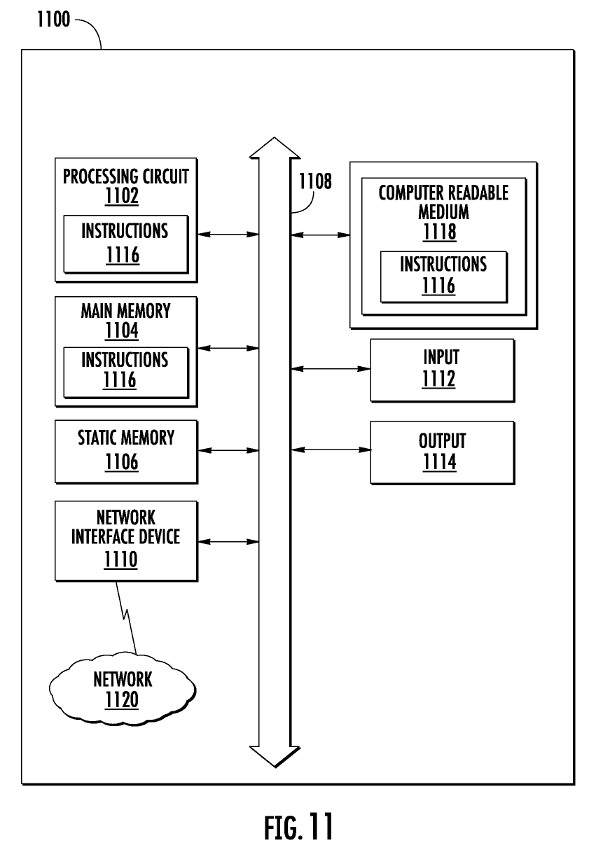

Any of the circuits, components, devices, modules, or the like in the WCS 100, and in particular the HEU 108 or the radio units 110(1)-110(M) can include a control circuit with associated memory having software or hardware that can implement the functions of the present disclosure. Accordingly, these devices may be considered and computer system or can include a computer system 1100, such as that shown in FIG. 11, to carry out their functions and operations. With reference to FIG. 11, the computer system 1100 includes a set of instructions for causing the multi-operator radio node component(s) to provide its designed functionality and the circuits discussed above. The multi-operator radio node component(s) may be connected (e.g., networked) to other machines in a LAN, an intranet, an extranet, or the Internet. The multi-operator radio node component(s) may operate in a client-server network environment or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user’s computer. The exemplary computer system 1100 in this embodiment includes a processing circuit or processor 1102 (which may be, for example, the control circuit of the CSC 310), a main memory 1104 (e.g., read-only memory (ROM), flash memory, dynamic random access memory (DRAM) such as synchronous DRAM (SDRAM), etc.), and a static memory 1106 (e.g., flash memory, static random access memory (SRAM), etc.), which may communicate with each other via a data bus 1108.

Alternatively, the processing circuit 1102 may be connected to the main memory 1104 and/or static memory 1106 directly or via some other connectivity means. The processing circuit 1102 may be a controller, and the main memory 1104 or static memory 1106 may be any type of memory.

The processing circuit 1102 represents one or more general-purpose processing circuits such as a microprocessor, central processing unit, or the like. More particularly, the processing circuit 1102 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1102 is configured to execute processing logic in instructions 1116 for performing the operations and steps discussed herein.

The computer system 1100 may further include a network interface device 1110. The computer system 1100 also may or may not include an input 1112 to receive input and selections to be communicated to the computer system 1100 when executing instructions 1116. The computer system 1100 also may or may not include an output 1114, including, but not limited to, a display, a video display unit (e.g., a liquid crystal display (LCD) or a cathode ray tube (CRT)), an alphanumeric input device (e.g., a keyboard), and/or a cursor control device (e.g., a mouse).

The computer system 1100 may or may not include a data storage device that includes instructions 1116 stored in a computer-readable medium 1118. The instructions 1116 may also reside, completely or at least partially, within the main memory 1104 and/or within the processing circuit 1102 during execution thereof by the computer system 1100, the main memory 1104, and the processing circuit 1102 also constituting the computer-readable medium 1118. The instructions 1116 may further be transmitted or received over a network 1120 via the network interface device 1110.

While the computer-readable medium 1118 is shown in an exemplary embodiment to be a single medium, the term “computer-readable medium” should be taken to include a single medium or multiple media (e.g., a centralized or distributed database and/or associated caches and servers) that store the one or more sets of instructions 1116. The term “computer-readable medium” should be taken to include a single medium or multiple media (e.g., a centralized or distributed database, and/or associated caches and servers) that store the one or more sets of instructions. The embodiments disclosed herein may be provided as a computer program product, or software, that may include a machine-readable medium (or computer–readable medium) having stored thereon instructions, which may be used to program a computer system (or other electronic devices) to perform a process according to the embodiments disclosed herein. The term “computer-readable medium” and “machine-readable medium” shall also be taken to include any medium that is capable of storing, encoding or carrying a set of instructions for execution by the processing circuit and that cause the processing circuit to perform any one or more of the methodologies of the embodiments disclosed herein. For example, a computer-readable medium or a machine-readable medium includes a machine-readable storage medium (e.g., read only memory (“ROM”), random access memory (“RAM”), magnetic disk storage medium, optical storage medium, flash memory devices, etc.), solid-state memories, optical media, magnetic media, and the like. Notwithstanding this broad definition, specifically excluded from this definition are electromagnetic carrier waves or other signals that have information encoded thereon or therein but lack tangible form.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

Unless specifically stated otherwise and as apparent from the previous discussion, it is appreciated that throughout the description, discussions utilizing terms such as “processing,” “computing,” “determining,” “displaying,” or the like refer to the action and processes of a computer system, or similar electronic computing device, that manipulates and transforms data and memories represented as physical (electronic) quantities within the computer system’s registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A wireless communication system (WCS) comprising:
a radio unit configured to send wireless signals to user equipment; and
a headend unit (HEU) communicatively coupled to the radio unit through a Common Public Radio Interface (CPRI)-compliant link and configured to:
receive an enhanced CPRI (eCPRI) signal from an outside source over an eCPRI-compliant link;
determine that an energy-saving command is present in the eCPRI signal; and
responsive to determining the energy-saving command is present in the eCPRI signal, send a CPRI-compliant signal with an indication of an energy-saving function to the radio unit.

2. The WCS of claim 1, wherein the indication comprises a bit corresponding to an antenna carrier (AxC).

3. The WCS of claim 2, wherein the indication comprises multiple bits corresponding to multiple AxC.

4. The WCS of claim 1, wherein the indication comprises an indication to mute a half-slot.

5. The WCS of claim 1, wherein the HEU is further configured to send a positioning command to the radio unit over the CPRI-compliant link.

6. The WCS of claim 1, wherein the CPRI-compliant signal has the indication in a vendor-specific portion of a frame.

7. The WCS of claim 1, wherein the CPRI-compliant signal has the indication in a reserved portion of a frame.

8. A headend unit (HEU) comprising:
an enhanced Common Public Radio Interface (eCPRI) interface configured to receive an eCPRI-compliant signal from a remote source, where the eCPRI-compliant signal contains an energy-saving command or a positioning command;
a CPRI interface configured to send CPRI-compliant signals to a remote radio unit; and
a control circuit coupled to the eCPRI interface and the CPRI interface and configured to:
assemble a CPRI-compliant frame comprising an indication of the energy-saving command or the positioning command; and
send the CPRI-compliant frame.

9. The HEU of claim 8, wherein the indication comprises a bit instructing an antenna carrier (AxC) to turn off.

10. The HEU of claim 8, wherein the indication comprises a plurality of bits instructing a corresponding plurality of AxC to turn off.

11. The HEU of claim 8, wherein the indication comprises a bit indicating that a half-slot is to be muted.

12. The HEU of claim 8, wherein the indication is positioned in a vendor-specific portion of a frame.

13. The HEU of claim 8, wherein the indication is positioned in a reserved portion of a frame.

14. A radio unit comprising:
a Common Public Radio Interface (CPRI) interface configured to couple to a CPRI-compliant link;
a control circuit coupled to the CPRI interface and configured to:
receive an indication in a CPRI-compliant frame, wherein the indication relates to an eCPRI-enabled command that is not available in a CPRI native frame;
responsive to receiving the indication, implement the eCPRI-enabled command.

15. The radio unit of claim 14, wherein the control circuit is configured to turn off an antenna carrier (AxC) responsive to receiving the indication.

16. The radio unit of claim 14, wherein the control circuit is further configured to turn off a transmitter responsive to receiving indications for all AxC corresponding to the transmitter.

17. The radio unit of claim 14, wherein the control circuit is configured to mute a half-slot responsive to receiving the indication.

18. A method comprising:
receiving an enhanced Common Public Radio Interface (eCPRI) compliant signal at a headend unit of a wireless communication system (WCS) wherein the eCPRI-compliant signal comprises a command that is not available in a native CPRI-compliant system;
embedding an indication of the command in a CPRI-compliant frame; and
sending the CPRI-compliant frame to a remote radio unit over a CPRI-compliant link.

19. The method of claim 18, wherein the command comprises an energy-saving command.

20. The method of claim 18, wherein the command comprises a positioning command.
